(19) United States
(12) Patent Application Publication
(10) Pub. No.: US 2008/0035211 A1
(43) Pub. Date: Feb. 14, 2008

(54) Valve having a particle retention element

(75) Inventors: Torsten Gerlich, Bensheim (DE); Jorg Bittner, Laudenbach (DE); Stefan Hettinger, Mutterstadt (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Carl Freudenberg KG, Weinheim (DE)

(21) Appl. No.: 11/891,560

(22) Filed: Aug. 10, 2007

(30) Foreign Application Priority Data
Aug. 14, 2006 (DE) 102006038090.8-12

(51) Int. Cl. F16K 51/00

(52) U.S. Cl. 137/238

(57) ABSTRACT

A valve is provided comprising a housing, said housing containing a channel for a fluid medium, and the channel having associated therewith a sealing element which cooperates with a sealing seat. Said sealing seat is positioned in a chamber with which are associated a particle retention element in order to provide simplicity in construction and ease of installation. Said valve is designed and improved in such a manner that, once installed, it ensures optimal operation at all times while being simple in construction and easy to install.

This application claims priority to German Patent application DE 102006038090.8-12, filed Aug. 14, 2006, the entire disclosure of which is hereby incorporated by reference.

### FIELD OF THE INVENTION

The present invention relates to a valve having a housing, said housing containing a channel for a fluid medium.

### BACKGROUND

Valves of the type mentioned at the outset are already known from the prior art. German Patent Application DE 102 22 218 A1, for example, discloses a solenoid valve which is used, in particular, as a purge valve for a fuel tank venting system in motor vehicles.

In the valve of the type described, a sealing element cooperates with a sealing seat in that the sealing element is pressed against the sealing seat. During operation, coarse particles such as chips, suspended particles, or other contaminants may be conveyed through the channel and accumulate on the sealing seat. If particles accumulate on the sealing seat, sealing closure of the channel is no longer guaranteed since the particles will space the sealing element at least slightly away from the sealing surface of the sealing seat. This leads to gaps through which the fluid medium may flow.

It is known in the prior art to provide screening devices upstream of the valve in order to prevent particles from entering the housing of the valve. However, providing a screen is time-consuming and expensive. Moreover, a screen always represents an additional component that must be operatively positioned when installing a valve in a fuel tank venting system. Therefore, the installer must take care to properly install the screen at the correct position, which results in increased installation costs.

### SUMMARY OF THE INVENTION

In accordance with an embodiment of the present invention, a valve comprising a housing, said housing containing a channel for a fluid medium, and the channel having associated therewith a sealing element which cooperates with a sealing seat, wherein the sealing seat is positioned in a chamber with which is associated a particle retention element.

### BRIEF DESCRIPTION OF DRAWINGS

The present invention is described in greater detail on the basis of the drawings, in which:

FIG. 1 shows a cross-sectional view of a solenoid valve including an upper part and a lower part; and

FIG. 2 shows a perspective view of a lower part in which are mounted particle retention elements.

### DETAILED DESCRIPTION OF THE INVENTION

An embodiment of the present invention provides a valve, that once installed, ensures optimal operation at all times while being simple in construction and easy to install by having the sealing seat of the valve positioned in a chamber with which are associated a particle retention element.

It was found that the valves of the type described are not very suitable in terms of construction because they require an additional component in order to provide satisfactory operation. This additional component is a screen and is relatively expensive. In a second step, it was found that the incorporation of a particle retention element inside the housing eliminates the need to install a separate component. By forming a particle retention element within the housing as integral parts of the valve, an installer can easily install the valve without having to insert additional components, such as screens, into a valve assembly. This eliminates complex assembly steps.

The particle retention element may take the form of rod-shaped elements. More specifically, the particle retention element may take the form of rods having rounded tips and forming the contour of a hedgehog or comb. This specific design enhances the particle retention capability. The particles are combed out of the entering medium in the manner of a comb. The rod-shaped elements may be arranged to form a labyrinth structure. The formation of a labyrinth structure causes the particles to travel a longer distance, thereby increasing the probability for the particles to be trapped on at least one rod-shaped element.

The rod-shaped elements may be oriented parallel to the channel. More specifically, it is conceivable for the rod-shaped elements to project orthogonally from a base surface of the housing. This specific design allows for simple manufacture of the housing, because orthogonally projecting elements can be easily removed from injection molds.

The chamber may have associated therewith at least one shield member which partially surrounds the sealing seat. The sealing seat may be surrounded by two shield members. This reliably prevents the fluid medium from flowing directly to the sealing seat, thereby ensuring that any particles present in fluid medium will be deflected from the sealing seat. In this process, the shield member acts as a baffle plate for the particles.

The shield member may have the shape of an arch. The arch-shaped configuration allows the fluid medium to be deflected around the sealing seat in a fluidically favorable manner. Since the sealing seat is circular in shape, an arch-shaped shield member makes it possible to deflect the fluid medium along paths which are concentric with respect to the sealing seat.

More specifically, two shield members may be provided, one shield member being disposed upstream of the sealing seat and one shield member being disposed downstream of the sealing seat. The shield members may be arranged with their concave sides facing each other so as to define an inflow channel through which the fluid medium can flow to the sealing seat. This specific design reduces the transport of particles to the sealing seat.

At least one shield member may have drop-shaped edge portions. This specific design prevents turbulence of the deflected fluid medium from occurring at the edge portions. This helps the fluid medium to enter the sealing seat in a fluidically favorable manner.

By providing a shield member, a collecting space may be created between a wall of the housing and the shield member. The collecting space may be ring-shaped and serve to allow for accumulation of particles. The accumulation of particles in the collecting space can be promoted because the collecting space is located in the lower region of the valve when in the installed position. In the installed position, the collecting space is oriented such that the particles will accumulate therein due to gravity.

The housing may have an inlet and an outlet which are disposed in collinear relationship. The inlet and the outlet may take the form of tubular ports to which supply lines can be attached by suitable means, such as quick connectors or hose clamps. The collinear arrangement of the inlet and the outlet allows for nearly non-turbulent passage of the fluid medium through the valve.

The housing may be composed of an upper part and a lower part, and the lower part may have associated therewith at least the particle retention elements. This specific design allows the lower part of the housing to be manufactured separately from the remainder of the valve. Thus, the lower part of the housing can be manufactured as a replaceable component in an inexpensive manner. When reliable valve operation is no longer guaranteed due to heavy contamination of the lower part, then the lower part may be replaced, if desired. For this purpose, the lower part and the upper part of the housing may be connected by a clip connection. In this case, a seal may be inserted between the lower part and the upper part of the housing. A permanent connection between the upper part and the lower part of the housing can be achieved by welding the upper and lower parts together. Welding eliminates the need for a seal. At least the lower part may be manufactured from polyamide, especially from polyamide 6.6. This material can be injection-molded and allows the lower part to be manufactured quickly and inexpensively. The upper part of the housing may also be manufactured from such materials.

In an embodiment of the present invention, the lower part of the housing may be oval in shape. The oval configuration makes it possible to reduce the flow velocity of the entering fluid medium, namely when the sealing seat is located in an enlarged portion of the lower part since the pattern of a flow field fans out from a narrow space toward a wide space, as a result of which the velocity of the fluid medium is reduced. In addition, the oval configuration makes it possible to provide a collecting space for particles, in which entering particles will accumulate.

In an embodiment of the present invention, the housing may have associated therewith a solenoid including a pole body and an armature, the armature cooperating with the sealing element. This specific embodiment, in which the valve described herein takes the form of a solenoid valve, enables fast actuation of the valve. Since solenoid valves can be adjusted particularly precisely to pressure changes and be switched in a defined manner, they are particularly suitable for use as a purge valve for a fuel tank venting system in motor vehicles.

In an embodiment of the present invention, the valve may be used for extracting fuel vapors from an activated carbon filter, and for supplying these vapors to an internal combustion engine, in particular an Otto engine, of a motor vehicle.

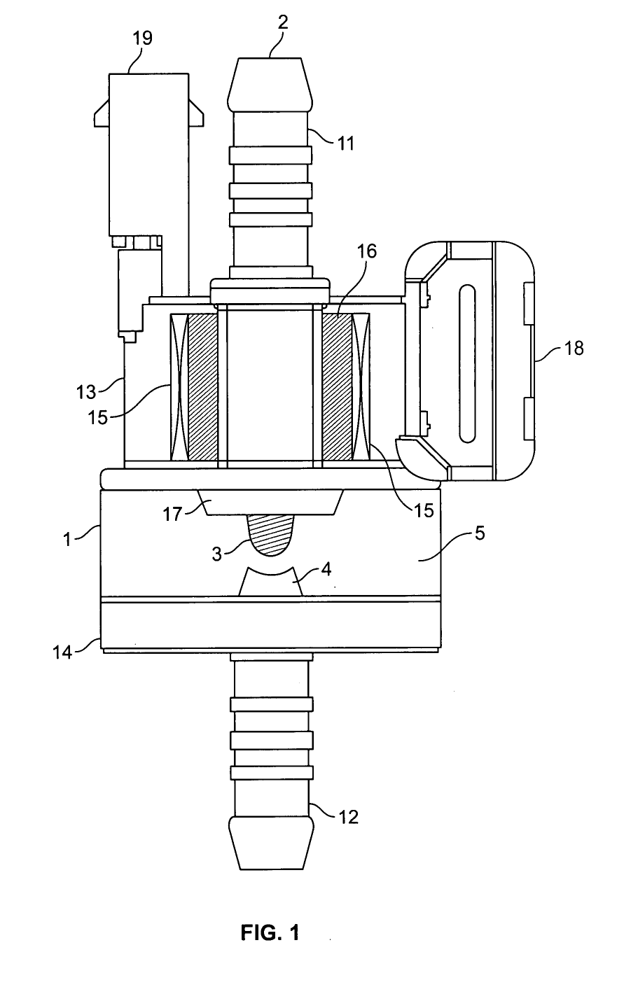

FIG. 1 shows a solenoid valve having a housing 1, said housing 1 containing a channel 2 for a fluid medium. Channel 2 has associated therewith a sealing element 3 which cooperates with a sealing seat 4. Engagement of sealing element 3 with sealing seat 4 causes channel 4 to be closed. Sealing seat 4 is positioned in a chamber 5 with which are associated particle retention element 6.

Housing 1 has an inlet 11 and an outlet 12 which are disposed in collinear relationship. Inlet 11 and the outlet 12 take the form of tubular ports to which hoses can be attached.

Housing 1 is composed of an upper part 13 and a lower part 14. A solenoid 15 including a pole body 16 and an armature 17 is associated with housing 1, namely with upper part 13. Armature 17 cooperates with sealing element 3. When activating solenoid 15, sealing element 3 is attracted, thereby opening sealing seat 4 and allowing the fluid medium to pass through channel 2.

FIG. 1 further shows a device 19 by which the solenoid can be connected to a downstream controller. Inlet 11 serves to connect the solenoid valve to an activated carbon filter. The solenoid valve further has a holder 18 for mounting the solenoid valve in an existing system. Lower part 14 and upper part 13 are manufactured from a plastic material, namely polyamide 6.6.

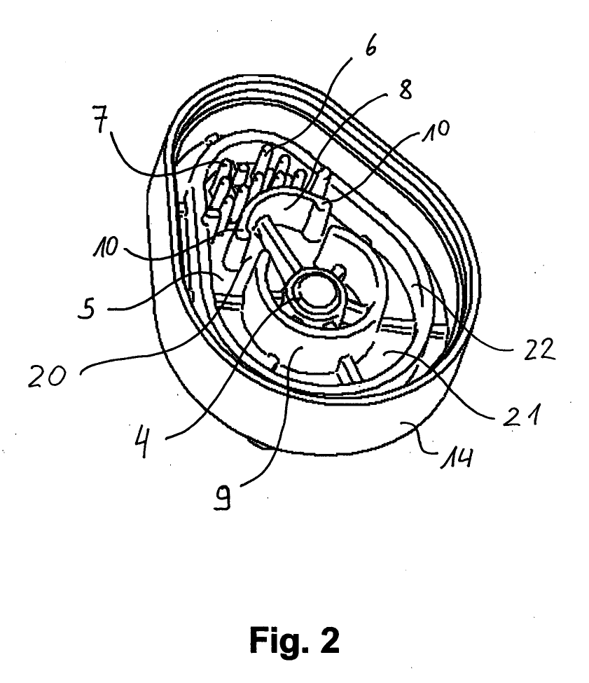

FIG. 2 shows lower part 14 in a perspective view. Lower part 14, as shown, is oval in shape. Lower part 14 has a chamber 5 formed therein in which particle retention elements 6 are mounted. Particle retention elements 6 take the form of rod-shaped elements 7. Rod-shaped elements 7 are oriented parallel to channel 2 and have rounded tips. Moreover, rod-shaped elements 7 are oriented parallel to each other and form a comb structure or hedgehog structure which is intended to trap any particles which may be transported into the interior of housing 1 by the fluid medium.

Chamber 5 has associated therewith at least one shield member 8 which partially surrounds sealing seat 4. Shield member 8 is arch-shaped and has drop-shaped edge portions 10. Chamber 5 further has provided therein a shield member 9 which also has the shape of an arch. Shield member 9 surrounds sealing seat 4 at least partially and, together with shield member 8, forms a gap 20 through which the fluid medium may flow to sealing seat 4. Particle retention elements 6 are associated with the illustrated lower part 14. Thus, lower part 14 may be manufactured as a separate part and be detachably or permanently associated with an upper part 13.

A collecting space 21 is formed between shield member 9 and a wall 22. When in the installed position, said collecting space is oriented such that the particles will accumulate therein due to gravity.

It is emphasized that the above exemplary embodiment is merely intended for the purposes of illustration for discussing the teaching of the present invention, but not for limiting it to this exemplary embodiment.

What is claimed is:

1. A valve comprising a housing, said housing containing a channel for a fluid medium, and the channel having associated therewith a sealing element which cooperates with a sealing seat, wherein the sealing seat is positioned in a chamber with which is associated a particle retention element.

2. The valve as recited in claim 1, wherein the particle retention element comprises a plurality of rod-shaped elements.

3. The valve as recited in claim 2, wherein the rod-shaped elements are oriented parallel to the channel.

4. The valve as recited in claim 1, wherein the chamber has associated therewith at least one shield member which partially surrounds the sealing seat.

5. The valve as recited in claim 4, wherein the shield member has the shape of an arch.

6. The valve as recited in claim 4, wherein the shield member has drop-shaped edge portions.

7. The valve as recited in claim 1, wherein the housing has an inlet and an outlet which are disposed in collinear relationship.

8. The valve as recited in claim 1, wherein the housing is composed of an upper part and a lower part, the lower part having associated therewith at least the particle retention element.

9. The valve as recited in claim 8, wherein at least the lower part is oval in shape.

10. The valve as recited in claim 1, wherein the housing has associated therewith a solenoid including a pole body and an armature, the armature cooperating with the sealing element.
